(19) United States
(12) Patent Application Publication
(10) Pub. No.: US 2024/0222599 A1
(43) Pub. Date: Jul. 4, 2024

(54) CAPACITOR ASSISTED BATTERY CELL WITH DUAL FUNCTION INTERLAYER

(71) Applicant: GM GLOBAL TECHNOLOGY OPERATIONS LLC, Detroit, MI (US)

(72) Inventors: Si CHEN, Shanghai (CN); Qili Su, Shanghai (CN); Dewen Kong, Shanghai (CN); Haijing Liu, Shanghai (CN); Mark W. Verbrugge, Sonoma, CA (US)

(21) Appl. No.: 18/403,867

(22) Filed: Jan. 4, 2024

(30) Foreign Application Priority Data
Jan. 4, 2023 (CN) 202310006147.0

(51) Int. Cl. H01M 4/139; H01M 4/36; H01M 4/62; H01M 10/0525

(52) U.S. Cl. CPC H01M 4/139; H01M 4/366; H01M 4/626; H01M 10/0525; H01M 2220/20

(57) ABSTRACT

A battery cell includes a cathode electrode comprising a cathode coating arranged on a cathode current collector and a separator. A dual function interlayer comprising capacitor material and lithium-ion source material is arranged one of between the cathode coating and the cathode current collector and between the cathode coating and the separator. An anode electrode is arranged adjacent to the separator and comprising an anode coating arranged on an anode current collector.

### CROSS-REFERENCE TO RELATED APPLICATIONS

This application claims the benefit of Chinese Patent Application No. 202310006147.0, filed on Jan. 4, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a capacitor assisted battery cell with a dual function interlayer.

Low voltage automotive battery systems such as 12V or 24V battery systems can be used for starting vehicles including an internal combustion engine (ICE) and/or to support vehicle accessory loads or other vehicle systems for these types of vehicles. Low voltage automotive battery systems can also be used to support vehicle accessory loads in electric vehicles (EVs) such as battery electric vehicles, hybrid vehicles and/or fuel cell vehicles. In some applications, the battery systems use lithium-ion battery cells due to their increased pulsed power density at both warm and cold temperatures and lower weight.

During starting, the battery system supplies current to a starter to crank the engine. When the vehicle is cold started, the battery needs to supply sufficient cranking power to overcome the pressure resistance at the top of the piston to start spark-ignition for gasoline engine or create sufficient heat in the cylinder to ignite the injected fuel for a diesel engine. In some applications, the battery system may continue to supply power for various electrical systems of the vehicle after the engine is started. An alternator or regeneration recharges the battery system.

### SUMMARY

A battery cell includes a cathode electrode comprising a cathode coating arranged on a cathode current collector and a separator. A dual function interlayer comprising capacitor material and lithium-ion source material is arranged one of between the cathode coating and the cathode current collector and between the cathode coating and the separator. An anode electrode is arranged adjacent to the separator and comprising an anode coating arranged on an anode current collector.

In other features, a capacitor layer arranged between the separator and the anode coating. A ceramic layer arranged between the dual function interlayer and the separator. A capacitor layer is arranged between the separator and the anode coating. A ceramic layer is arranged between the capacitor layer and the separator.

In other features, a capacitor layer is arranged between the separator and the anode coating. A first ceramic layer is arranged between the dual function interlayer and the separator. A second ceramic layer is arranged between the capacitor layer and the separator.

In other features, the capacitor material is selected from a group consisting of activated carbon, a metal oxide, a metal sulfides, a polymer, and combinations thereof. The lithium-ion source material is selected from a group consisting of lithium nitride, lithium nickel oxide, Li₅FeO₄, lithium rhenium oxide, Li₆CoO₄, Li₃C2(PO₄)₃, LiF and LiF/metal composites, Li₂O and LiO/metal composites, Li₂RuO₃, LiCoO₂ (LCO), and combinations thereof.

In other features, the ceramic layer is selected from a group consisting of aluminum oxide, silicon dioxide, a metal oxide, a metal sulfide, and combinations thereof. At least one of the lithium-ion source material comprises 2% to 50% weight of the dual function interlayer and the dual function interlayer includes a polymer binder selected from poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), styrene ethylene butylene styrene copolymer (SEBS), and combinations thereof. The cathode coating includes a cathode active material selected from a group consisting of a rock salt layered oxide, a spinel compound, an olivine compound, a tavorite compound, a borate compound, a silicate compound, an organic compound, and a combination of one or more of a rock salt layered oxide, a spinel compound, an olivine compound, a tavorite compound.

A method for manufacturing a dual function layer for a battery cell includes providing film including a cathode electrode including a cathode coating arranged on a cathode current collector; creating a slurry by mixing a capacitor material, a lithium-ion source material, a polymer binder, and a solvent; delivering the slurry onto the cathode coating to create a dual function interlayer; and heating the cathode electrode and the dual function interlayer.

In other features, the capacitor material is selected from a group consisting of activated carbon, a metal oxide, a metal sulfides, a polymer, and combinations thereof. The lithium-ion source material is selected from a group consisting of lithium nitride, lithium nickel oxide, Li₅FeO₄, lithium rhenium oxide, Li₆CoO₄, Li₃C₂(PO₄)₃, LiF and LiF/metal composites, Li₂O and LiO/metal composites, Li₂RuO₃, LiCoO₂ (LCO), and combinations thereof. The lithium-ion source material comprises 2% to 50% weight of the dual function interlayer. The cathode coating includes a cathode active material selected from a group consisting of a rock salt layered oxide, a spinel compound, an olivine compound, a tavorite compound, a borate compound, a silicate compound, an organic compound, and a combination of one or more of a rock salt layered oxide, a spinel compound, an olivine compound, a tavorite compound.

A method for manufacturing a dual function layer for a battery cell comprises providing film including a separator and a ceramic layer; creating a slurry by mixing a capacitor material, a lithium-ion source material, a polymer binder, and a solvent; delivering the slurry onto the ceramic layer to create a dual function interlayer; and heating the separator, the ceramic layer, and the dual function interlayer to reduce the solvent.

In other features, the capacitor material is selected from a group consisting of activated carbon, a metal oxide, a metal sulfides, a polymer, and combinations thereof. The lithium-ion source material is selected from a group consisting of lithium nitride, lithium nickel oxide, Li₅FeO₄, lithium rhenium oxide, Li₆CoO₄, Li₃C₂(PO₄)₃, LiF and LiF/metal composites, Li₂O and LiO/metal composites, Li₂RuO₃, LiCoO₂ (LCO), and combinations thereof. The lithium-ion source material comprises 2% to 50% weight of the dual function interlayer.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a side cross-sectional view of a battery cell including a dual function interlayer arranged between a cathode electrode and a separator according to the present disclosure;

FIG. 1B illustrates a dual function interlayer according to the present disclosure;

FIG. 2 is a side cross-sectional view of a battery cell including a dual function interlayer arranged between a cathode coating and a cathode current collector according to the present disclosure;

FIG. 3 is a side cross-sectional view of a battery cell including a dual function interlayer arranged between a cathode electrode and a separator and a capacitor layer arranged between the separator and the anode electrode according to the present disclosure;

FIG. 4 is a side cross-sectional view of a battery cell including a dual function interlayer arranged adjacent to a cathode electrode, a ceramic layer arranged between the dual function interlayer and the separator, and a capacitor layer arranged between the separator and the anode electrode according to the present disclosure;

FIG. 5 is a side cross-sectional view of a battery cell including a dual function interlayer arranged adjacent to a cathode electrode, a first ceramic layer arranged between the dual function interlayer and the separator, a second ceramic layer arranged adjacent to the separator, and a capacitor layer arranged between the second ceramic layer and the anode electrode according to the present disclosure;

FIG. 6 illustrates a method for manufacturing a dual function interlayer on a cathode electrode according to the present disclosure;

FIG. 7 illustrates a method for manufacturing a dual function interlayer on a ceramic layer and a separator according to the present disclosure;

FIGS. 8A and 8B are side cross-sectional views of battery cells including a dual function interlayer according to the present disclosure;

FIG. 9 is a side cross-sectional view of a battery cell including a dual function interlayer and a capacitor layer according to the present disclosure;

FIG. 10 is a side cross-sectional view of a battery cell including a dual function interlayer and a first ceramic layer according to the present disclosure; and

FIG. 11 is a side cross-sectional view of a battery cell including a dual function interlayer and a first ceramic layer, and a capacitor layer and a second ceramic layer according to the present disclosure.

In the drawings, reference numbers may be reused to identify similar and/or identical elements.

### DETAILED DESCRIPTION

While the battery cells are described herein in the context of vehicles, the battery cells can be used in stationary applications and/or in other applications.

Capacitor assisted battery (CAB) cells have superior low temperature performance as compared to lithium-ion (Li-ion) batteries without capacitors. Even though the CAB cells retain high-power performance with the assistance of the capacitor, active lithium loss is irreversibly accelerated in response to high operating temperatures due to anode/electrolyte interfacial reactions.

Battery cells according to the present disclosure include a lithium-ion battery (LIB) with a lithium-ion capacitor (LIC) acting as a dual function interlayer between the cathode electrode and the separator to enhance electrochemical performance. The capacitor material of the dual function interlayer provides quick power response, improves battery power performance (especially during low temperature cranking), and has a tunable hybridization ratio. The lithium source material of the dual function interlayer acts an additional source of reversible Li-ions, reduces Li-ion consumption from electrolyte and forms a stable solid electrolyte interface (SEI), offsets the initial lithium loss in the LIB and increases reversible Li-ion capacity, and enhances long-term cycling performance.

Referring now to FIG. 1A, a battery cell 100 includes an anode electrode including an anode current collector 110 and an anode coating 114. The anode coating 114 includes anode active material, binder, solvent, and/or additives. A separator 118 is arranged adjacent to the anode coating 114. A dual function interlayer 122 is arranged between a cathode electrode (including a cathode coating 124 and a cathode current collector 126) and the separator 118. In some examples, the dual function interlayer 122 has a thickness in a range from 1 μm to 20 μm. The cathode coating 124 includes cathode active material, binder, solvent, and/or additives. In FIG. 1B, the dual function interlayer 122 includes capacitor material 156 and lithium-ion source material 152.

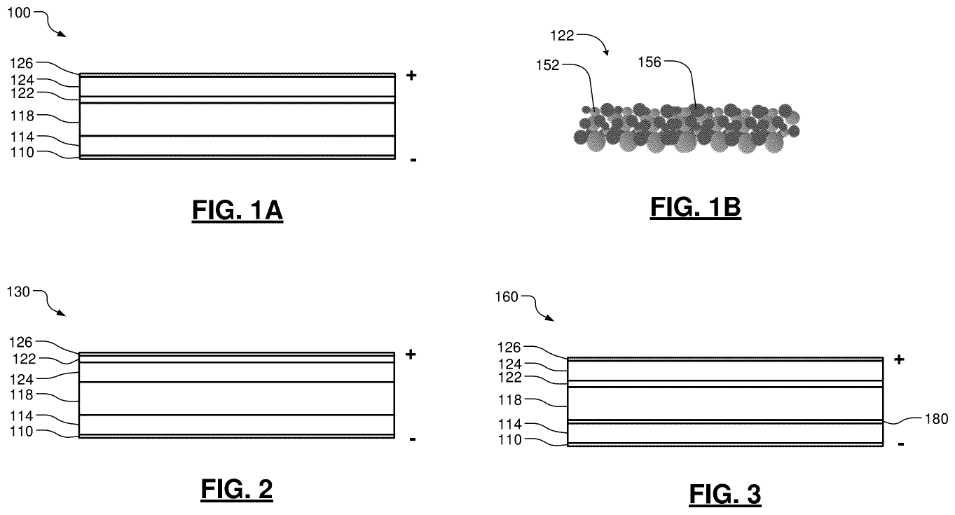

Referring now to FIG. 2, a battery cell 130 includes the layers described above in FIG. 1 except that the dual function interlayer 122 is arranged between the cathode current collector 126 and the cathode coating 124.

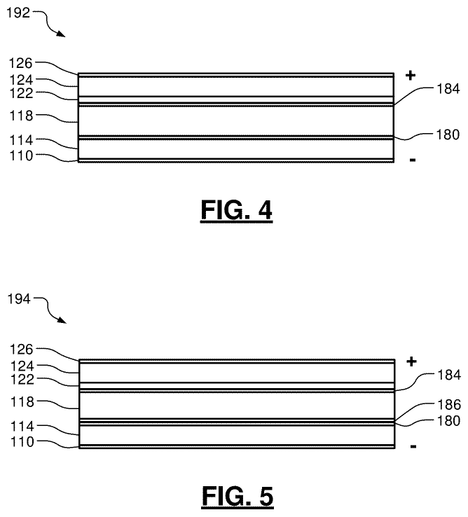

Referring now to FIG. 3, a battery cell 160 includes the layers described above in FIG. 1 and further includes a capacitor layer 180 arranged between the separator 118 and the anode coating 114. In other words, the battery cell 160 is an electric double layer capacitor (EDLC).

In some examples, the capacitor layer 180 has a thickness in a range from 1 μm to 20 μm. The dual function interlayer 122 includes capacitor material and Li-ion source material and the capacitor layer 180 includes capacitor material. In some examples, the total capacity of the capacitors (including the dual function interlayer 122 and the capacitor layer 180) are the same.

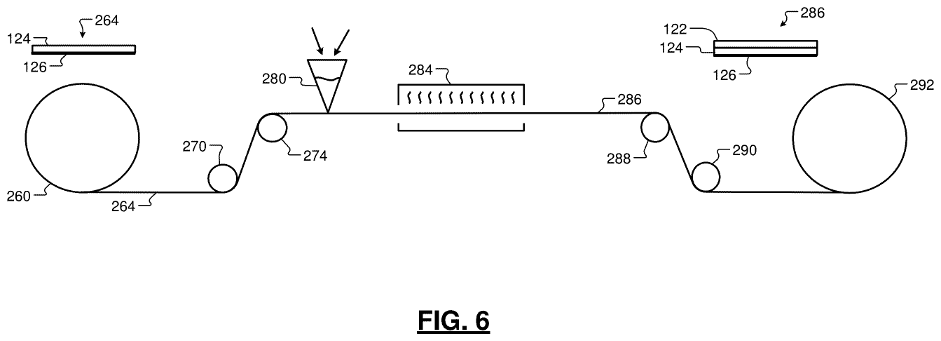

Referring now to FIG. 4, a battery cell 192 includes the layers described above in FIG. 1 and further includes a first ceramic layer 184 arranged between the separator 118 and the dual function interlayer 122. In FIG. 5, a battery cell 194 includes the layers described above in FIG. 4 and further includes a second ceramic layer 186 arranged between the separator 118 and the capacitor layer 180. In some examples, the first and second ceramic layers 184 and 186 have a thickness in a range from 0.5 μm to 2.0 μm.

The first and second ceramic layers 184 and 186 act as functional separators to reduce the potential for internal short circuits in hybrid cells. The first and second ceramic layers 184 and 186 increase mechanical strength for the Li-ion source/capacitor layer coating.

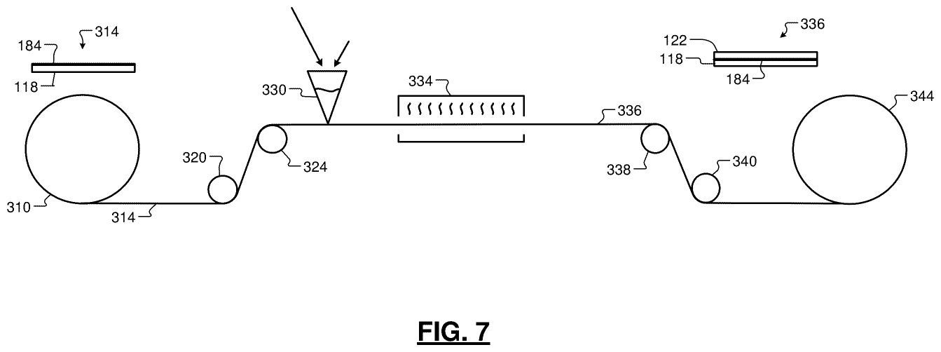

Referring now to FIG. 6, a method for manufacturing a dual function interlayer on a cathode electrode is shown. A roll 260 provides a web (including the cathode coating 124 on the cathode current collector 126 at 264) to rollers 270 and 274, which perform tensioning and/or height adjustment. A coating device 280 applies a slurry comprising a mixture of capacitor material, lithium-ion source material, a polymer binder, and solvent onto the cathode coating 124 of the web.

In some examples, the capacitor material comprises activated carbon, the Li-ion source material comprises Li₅FeO₄, the solvent comprises N-Methyl-2-pyrrolidone (NMP), and the polymer binder comprises polyvinylidene fluoride or polyvinylidene difluoride (PVDF), although other materials described below can be used.

The slurry is stirred and supplied onto the cathode coating 124 and then dried at 284. The web including the cathode coating 124, the cathode current collector 126, and the dual function interlayer 122 is fed to rollers 288 and 290, which perform tensioning and/or height adjustment. The web including the cathode coating 124, the cathode current collector 126, and the dual function interlayer 122 are wound around a roller 294.

Referring now to FIG. 7, a method for manufacturing a dual function interlayer on the separator 118 is shown. A roll 310 provides a web including the separator 118 and the first ceramic layer 184 at 314 to rollers 320 and 324, which perform tensioning and/or height adjustment. A coating device 330 supplies a slurry comprising a mixture of capacitor material, lithium-ion source material, a polymer binder, and solvent onto the first ceramic layer 184.

In some examples, the capacitor material comprises activated carbon, the Li-ion source material comprises Li₅FeO₄, the solvent comprises water, and the polymer binder comprises carboxymethyl cellulose binder (CMC), although other materials described below can be used.

The slurry is stirred and supplied onto the first ceramic layer 184 and then dried at 334. The web including the separator 118, the second ceramic layer 186, and the dual function interlayer 122 are fed over rollers 338 and 340, which perform tensioning and/or height adjustment. The web including the separator 118, the first ceramic layer 184, and the dual function interlayer 122 is wound around a roller 344.

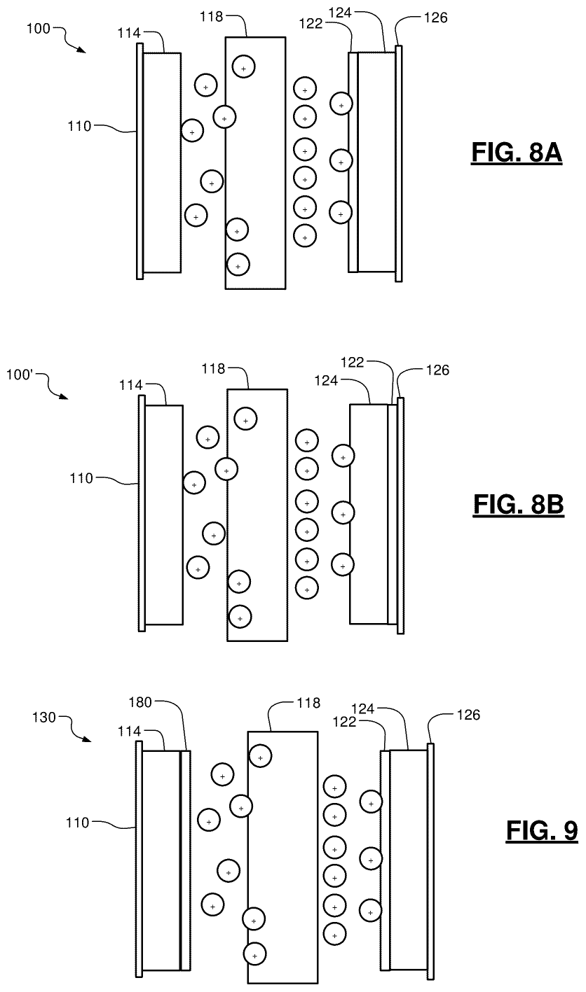

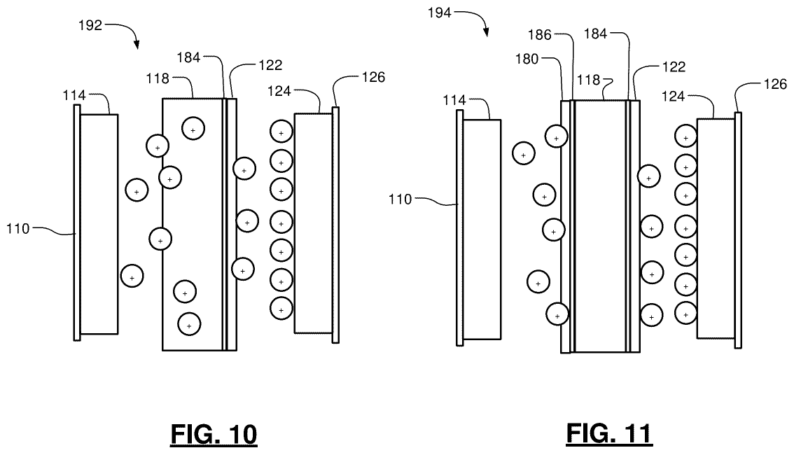

Referring now to FIGS. 8A, 8B, and 9, the battery cells 100, 100′ and 130 including a dual function interlayer and/or the capacitor are shown, respectively. The dual function interlayer 122 can also be arranged between the cathode coating and the cathode current collector as shown in FIG. 8B. In FIGS. 10 and 11, battery cells 192 and 194 including the dual function interlayer 122 and the first ceramic layer 184 and/or the capacitor 180 and the second ceramic layer 186 are shown.

In some examples, the dual function interlayer includes a lithium source material comprising a material selected from a group consisting of lithium nitride (Li₃N), lithium nickel oxide (e.g., Li_{0.65}N_{1.35}O₂), Li₅FeO₄, lithium rhenium oxide (Li₅ReO₆), Li₆CoO₄, and Li₃C₂(PO₄)₃, LiF and LiF/metal composites (e.g., LiF/Co and LiF/Fe), Li₂O and LiO/metal composites (e.g., Li₂O/Co, Li₂O/Fe, and Li₂O/Ni), Li₂RuO₃, LiCoO₂ (LCO), and combinations thereof. In some examples, the lithium source material comprises 2% to 50% weight of the dual function interlayer.

In some examples, the cathode active material includes a material selected from a group consisting of a rock salt layered oxide, a spinel compound, an olivine compound, a tavorite compound, a borate compound, a silicate compound, an organic compound, and a combination of one or more of a rock salt layered oxide, a spinel compound, an olivine compound, a tavorite compound.

In some examples, the rock salt layered oxide comprises a material selected from a group consisting of LiNixMnCo_{1-x-y}O₂, LiNiMn₁₋ₓO₂, Li₁₊ₓMO₂ (e.g., LiCoO₂, LiNiO₂, LiMnO₂, LiNi_{0.5}Mn_{0.5}O₂) NMC111, NMC523, NMC622, NMC721, NMC811, NCA, NM, NMA, etc. In some examples, the spinel compound comprises a material selected from a group consisting of LiMn₂O₄, LiNi_{0.5}Mn_{1.5}O₄. etc.

In some examples, the olivine compound comprises a material selected from a group consisting of LiV₂(PO₄)₃, LiFePO₄, LiMnPO₄, etc. In some examples, the tavorite compound comprises a material selected from a group consisting of LiVPO₄F. In some examples, the borate compound comprises a material selected from a group consisting of LiFeBO₃, LiCoBO₃, and LiMnBO₃. In some examples, the silicate compound comprises a material selected from a group consisting of Li₂FeSiO₄, Li₂MNSiO₄, and LiMnSiO₄F. In some examples, the organic compound comprises a material selected from a group consisting of dilithium (2,5-dilithiooxy)terephthalate and polyimide. In some examples, the cathode active material includes a combination of one or more of the rock salt layered oxide, the spinel compound, the olivine compound, and/or the tavorite compound.

In some examples, the anode active material comprises a material selected from a group consisting of carbonaceous material (e.g., graphite, hard carbon, soft carbon etc.), silicon, silicon mixed with graphite, Li₄Ti₅O₁₂, transition-metals (e.g., Sn), metal oxide/sulfide (e.g., TiO₂, FeS and the likes), and other lithium-accepting anode materials. In some examples, the anode active material includes Li metal and a Li alloy.

In some examples, the capacitor materials comprise a material selected from a group consisting of activated carbon, metal oxides (e.g., MOx, where M=Co, Ru, Nb, etc.), metal sulfides (e.g., TiS₂, CuS, FeS, etc.), polymers (e.g., polyaniline, polyacetylene, etc.), and combinations thereof.

In some examples, the ceramic material comprises a material selected from a group consisting of aluminum oxide (Al₂O₃), silicon dioxide (SiO₂), a metal oxide (e.g., such as MgO, TiO₂), and a metal sulfide (e.g., TiS₂). In some examples, the separator comprises porous polyethylene (PE).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
a cathode electrode comprising a cathode coating arranged on a cathode current collector;
a separator;
a dual function interlayer comprising capacitor material and lithium-ion source material arranged one of:
between the cathode coating and the cathode current collector, and
between the cathode coating and the separator; and
an anode electrode arranged adjacent to the separator and comprising an anode coating arranged on an anode current collector.

2. The battery cell of claim 1, further comprising a capacitor layer arranged between the separator and the anode coating.

3. The battery cell of claim 1, further comprising a ceramic layer arranged between the dual function interlayer and the separator.

4. The battery cell of claim 1, further comprising:
a capacitor layer arranged between the separator and the anode coating; and
a ceramic layer arranged between the capacitor layer and the separator.

5. The battery cell of claim 1, further comprising:
a capacitor layer arranged between the separator and the anode coating; and
a first ceramic layer arranged between the dual function interlayer and the separator; and
a second ceramic layer arranged between the capacitor layer and the separator.

6. The battery cell of claim 1, wherein the capacitor material is selected from a group consisting of activated carbon, a metal oxide, a metal sulfides, a polymer, and combinations thereof.

7. The battery cell of claim 1, wherein the lithium-ion source material is selected from a group consisting of lithium nitride, lithium nickel oxide, Li₅FeO₄, lithium rhenium oxide, Li₆CoO₄, LisC₂(PO₄)₃, LiF and LiF/metal composites, Li₂O and LiO/metal composites, Li₂RuO₃, LiCoO₂ (LCO), and combinations thereof.

8. The battery cell of claim 3, wherein the ceramic layer is selected from a group consisting of aluminum oxide, silicon dioxide, a metal oxide, a metal sulfide, and combinations thereof.

9. The battery cell of claim 1, wherein at least one of:
the lithium-ion source material comprises 2% to 50% weight of the dual function interlayer, and
the dual function interlayer includes a polymer binder selected from poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), styrene ethylene butylene styrene copolymer (SEBS), and combinations thereof.

10. The battery cell of claim 1, wherein the cathode coating includes a cathode active material selected from a group consisting of a rock salt layered oxide, a spinel compound, an olivine compound, a tavorite compound, a borate compound, a silicate compound, an organic compound, and a combination of one or more of a rock salt layered oxide, a spinel compound, an olivine compound, a tavorite compound.

11. A method for manufacturing a dual function layer for a battery cell, comprising:
providing film including a cathode electrode including a cathode coating arranged on a cathode current collector;
creating a slurry by mixing a capacitor material, a lithium-ion source material, a polymer binder, and a solvent;
delivering the slurry onto the cathode coating to create a dual function interlayer; and
heating the cathode electrode and the dual function interlayer.

12. The method of claim 11, wherein the capacitor material is selected from a group consisting of activated carbon, a metal oxide, a metal sulfides, a polymer, and combinations thereof.

13. The method of claim 11, wherein the lithium-ion source material is selected from a group consisting of lithium nitride, lithium nickel oxide, Li₅FeO₄, lithium rhenium oxide, Li₆CoO₄, LisC₂(PO₄)₃, LiF and LiF/metal composites, Li₂O and LiO/metal composites, Li₂RuO₃, LiCoO₂ (LCO), and combinations thereof.

14. The method of claim 11, wherein the lithium-ion source material comprises 2% to 50% weight of the dual function interlayer.

15. The method of claim 11, wherein the cathode coating includes a cathode active material selected from a group consisting of a rock salt layered oxide, a spinel compound, an olivine compound, a tavorite compound, a borate compound, a silicate compound, an organic compound, and a combination of one or more of a rock salt layered oxide, a spinel compound, an olivine compound, a tavorite compound.

16. A method for manufacturing a dual function layer for a battery cell, comprising:
providing film including a separator and a ceramic layer;
creating a slurry by mixing a capacitor material, a lithium-ion source material, a polymer binder, and a solvent;
delivering the slurry onto the ceramic layer to create a dual function interlayer; and
heating the separator, the ceramic layer, and the dual function interlayer to reduce the solvent.

17. The method of claim 16, wherein the capacitor material is selected from a group consisting of activated carbon, a metal oxide, a metal sulfides, a polymer, and combinations thereof.

18. The method of claim 16, wherein the lithium-ion source material is selected from a group consisting of lithium nitride, lithium nickel oxide, Li₅FeO₄, lithium rhenium oxide, Li₆CoO₄, Li₃C₂(PO₄)₃, LiF and LiF/metal composites, Li₂O and LiO/metal composites, Li₂RuO₃, LiCoO₂ (LCO), and combinations thereof.

19. The method of claim 16, wherein the lithium-ion source material comprises 2% to 50% weight of the dual function interlayer.
